(19) United States
(12) Patent Application Publication
(10) Pub. No.: US 2008/0271702 A1
(43) Pub. Date: Nov. 6, 2008

(54) FUEL-SAVING ACCELERATOR FOR INTERNAL COMBUSTION ENGINE

(75) Inventor: Cheuk Pui TAM, HONG KONG (HK)

Correspondence Address: J C PATENTS, INC., 4 VENTURE, SUITE 250, IRVINE, CA, 92618, US

(73) Assignee: EVOLUTION HYDROPOWER TECHNOLOGY LIMITED, KOWLOON (HK)

(21) Appl. No.: 12/112,777

(22) Filed: Apr. 30, 2008

(30) Foreign Application Priority Data
May 3, 2007 (HK) 07104697.1

(51) Int. Cl. F02B 47/02

(52) U.S. Cl. 123/25 A; 44/301

(57) ABSTRACT

The present invention discloses a fuel-saving accelerator for internal combustion engine, which comprises a water tank for storing water therein as auxiliary fuel for the inner combustion engine; a water processing unit communicating with the water tank to process the water supplied from the water tank; and a water control unit which is connected between the water processing unit and a combustion chamber of the inner combustion engine to control the amount of the processed water supplied from the water processing unit and supply a controlled amount of water to the combustion chamber.

### CROSS-REFERENCE TO RELATED APPLICATIONS

This application claims the priority benefits of Hong Kong Short-term Patent Application No. 07104697.1 filed on May 3, 2007, the contents of which are hereby incorporated by reference in its entirety.

### FIELD OF THE INVENTION

The present invention relates to a fuel-saving accelerator, particularly to a fuel-saving accelerator for internal combustion engine, which could reduce the fuel consumption of the internal combustion engine and at the same time enhance the dynamic performance thereof.

### BACKGROUND OF THE INVENTION

With the development of society, the demand for high speed is more and more critical, and internal combustion engines are used as power sources of vehicles more and more widely. However, with the rocketing of the price of fuel oil, the operation cost of the internal combustion engines using oil as the fuel rises sharply. Therefore, it is desirable to use relatively cheep fuel as a substitute. However, presently, the cost of alternative fuel is even higher than that of common fuel oil, and the performance of such alternative fuel is not stable, thus, it is not prevalent to use alternative fuel now.

In addition, during the combustion of fuel to generate power, it is unavoidable that the burning of the fuel oil may not be efficient, thus, the efficiency of fuel oil is low and a large amount of harmful exhaust gas is generated.

Therefore, the development of a fuel-saving accelerator based on the existing internal combustion engine is desirable all along, which could improve the combustion efficiency of fuel oil, to lower the fuel consumption and reduce the environmental pollution caused by the discharging of exhaust gas.

### SUMMERY OF THE INVENTION

With respect to the above problems, the main object of the present invention is to provide a fuel-saving accelerator for internal combustion engine which may comprise a water tank for storing water therein as auxiliary fuel for the inner combustion engine; a water processing unit communicating with the water tank to process the water supplied from the water tank; and a water amount control unit connected between the water processing unit and a combustion chamber of the internal combustion engine to control the amount of the processed water supplied from the water processing unit and supply a controlled amount of water to the combustion chamber.

Preferably, the water processing unit may comprise an inlet and an outlet formed at opposite ends of the water processing unit and an inner cavity provided between the inlet and the outlet, in which the inner cavity contains materials for processing the water. The inner cavity is provided with organic absorption cotton for absorbing particles and impurities in the water, absorbent charcoal for absorbing the harmful metals and other heavy metals in the water, and ion-exchange resin for lowering the concentration of calcium and magnesium ion in the water. The water processing unit may adjust the pH value of the water to pH 6˜8.

Preferably, the water amount control unit may comprise a through hole formed therein, and an inlet and an outlet formed at opposite ends of the through hole. The diameter d of the through hole is determined according to the following equation d=(Fc/Cc)*Apui, where Apui is a constant value of 8000, Fc is the fuel consumption of the internal combustion engine, while Cc is the cylinder capacity of the internal combustion engine. The water amount control unit may be connected to an intake port of the combustion chamber through a connection tube, to supple a controlled amount of water to the combustion chamber during the induction stroke of the internal combustion engine.

Preferably, the water processing unit and/or the water amount control unit may be provided within the water tank.

With the present fuel-saving accelerator, the combustion efficiency of fuel oil in the internal combustion engine may be improved, the dynamic performance of the internal combustion engine may be enhanced, thus, the fuel consumption could be lowered, and the environmental pollution of the exhaust gas could be reduced.

### BRIEF DESCRIPTION OF THE DRAWINGS

The embodiments of the fuel-saving accelerator for internal combustion engine according the present invention will be described in detail with reference to the accompanying drawings, in which:

FIG. 1 is a schematic view illustrating a fuel-saving accelerator according to the present invention, which is connected to an internal combustion engine;

FIG. 2 is a schematic view illustrating a water processing unit of the fuel-saving accelerator according to the present invention;

FIG. 3 is a schematic view illustrating a water amount control unit of the fuel-saving accelerator according to the present invention;

FIG. 4 illustrates a V-T curve graph of the samples in a first test of the present fuel-saving accelerator during the acceleration from standing start;

FIG. 5 illustrates a V-S curve graph of the samples in the first test of the present fuel-saving accelerator during the acceleration from standing start;

FIG. 6 illustrates a V-S curve graph of the samples in a second test of the present fuel-saving accelerator during the acceleration from standing start;

FIG. 7 illustrates a V-T curve graph of the samples in the second test of the present fuel-saving accelerator during the acceleration from standing start;

FIG. 8 illustrates a V-S curve graph of the samples in the second test of the present fuel-saving accelerator during the acceleration from 30 km/h to 110 km/h with direct drive transmission;

FIG. 9 illustrates a V-T curve graph of the samples in the second test of the present fuel-saving accelerator during the acceleration from 30 km/h to 110 km/h with direct drive transmission;

FIG. 10 illustrates a V-S curve graph of the samples in the second test of the present fuel-saving accelerator during the acceleration from 30 km/h to 110 km/h with maximum drive transmission; and

FIG. 11 illustrates a V-T curve graph of the samples in the second test of the present fuel-saving accelerator during the acceleration from 30 km/h to 110 km/h with maximum drive transmission.

### DETAILED DESCRIPTION OF THE INVENTION

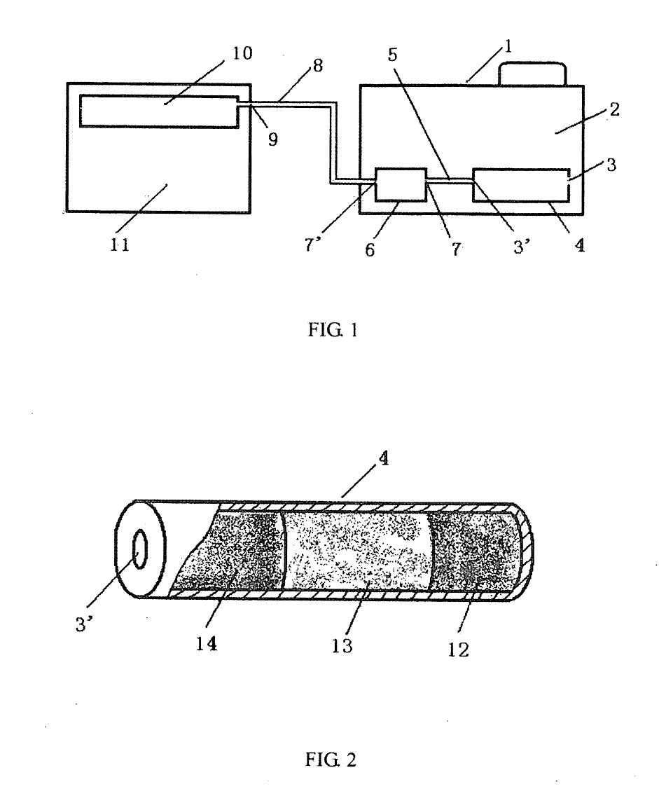

As shown in FIG. 1, the fuel-saving accelerator 1 for internal combustion engine of the present invention comprises a water tank 2, a water processing unit 4 and a water amount control unit 6. The water tank 2 stores water which is used as auxiliary fuel for the internal combustion engine. When the amount of the water stored the water tank reduces to a preset lower threshold, fresh water will be supplied to the water tank, to maintain the amount of water to a level sufficient for the normal operation of the internal combustion engine. The water tank 2 supplies water to the water processing unit 4 through the inlet 3 of the latter, and then the water will be processed by the water processing unit. The processed water is output from the outlet 3′ of the water processing unit 4, and then is supplied to the water amount control unit 6 through the inlet 7 of the water amount control unit via a tube 5. The water amount control unit 6 will control the amount of water output therefrom, and supplies a controlled amount of water to the combustion chamber 10 of the internal combustion engine 11 via the outlet 7′ thereof, a connection tube 8 and an intake port 9 of the internal combustion engine. In the combustion chamber, the water will be mixed with the fuel oil, and then the mixture of water and fuel oil will be burnt together, thus, the combustion rate of the fuel oil could be improved.

In an example shown in FIG. 2, the water processing unit 4 includes an inner cavity to contain the materials for processing the water, an inlet 3 and an outlet 3′ provided at opposite ends of the water processing unit 4, in which the water to be processed is supplied to the inner cavity through the inlet 3 and then the processed water is output through the outlet 3′. The inner cavity of the water processing unit 4 may be divided into three sections which are provided with organic absorption cotton 12, absorbent charcoal 13, and ion-exchange resin 14 respectively, in which the organic absorption cotton 12 is used to absorb particles and impurities in the water, the absorbent charcoal 13 is used to absorb the harmful metals and other heavy metals in the water, and the ion-exchange resin 14 is used to lower the concentration of calcium and magnesium ion in the water. The water processing unit 4 could remove the impurities in the water and adjust the pH value of the water. Preferably, the water processing unit 4 may adjust the pH value of the water to pH 6˜8. The water processing unit 4 may be of column shape, as shown in FIG. 2, or be in any other suitable forms. Alternatively, the inner cavity of the water processing unit 4 could be filled with other suitable materials for processing the water.

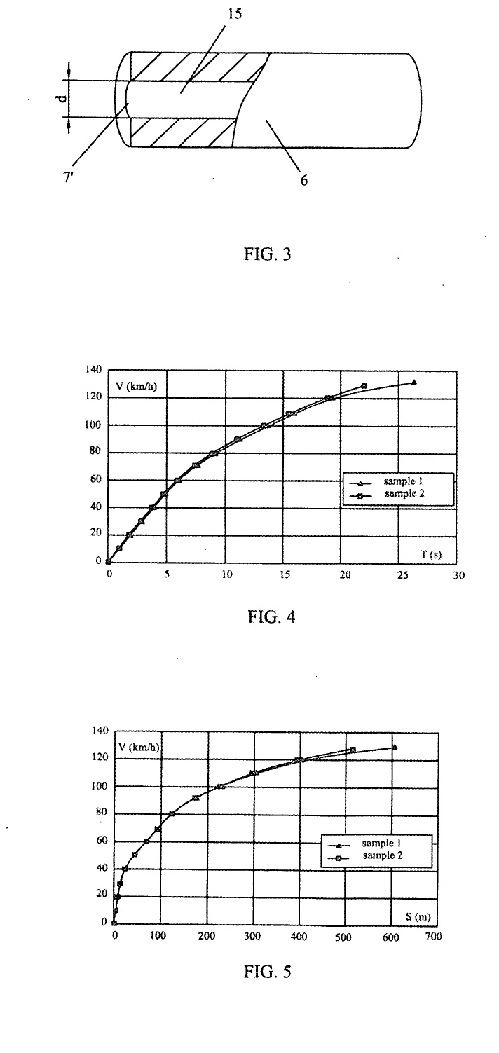

FIG. 3 shows an example of the water amount control unit 6 of the fuel-saving accelerator 1 according to the present invention. The water amount control unit 6 is provided with a through hole 15, and an inlet 7 and an outlet 7′ of the water amount control unit 6 are formed on the opposite ends of the through hole 15. The water amount control unit 6 may be made of stainless steel, copper or other suitable materials. The diameter d of the through hole 15 is determined according to the following equation.

d=(Fc/Cc)*Apui

where Apui is a constant value of 8000 whose unit of (cc*km/L)*mm, Fc is the fuel consumption of the internal combustion engine whose unit is L/km, while Cc is the cylinder capacity of the internal combustion engine whose unit is cc (cubic centimeter).

The water processed by the water processing unit 4 is supplied to the water amount control unit 6 through the transmission tube 5 and the inlet 7, and the water amount control unit 6 controls the amount of water output therefrom by virtue of the through hole 15, and then the controlled amount of water is supplied to the combustion chamber of the internal combustion engine through the outlet 7′ and the connection tube 8.

Through determining the diameter of the through hole 15 within the water amount control unit 6 according to the above-mentioned equation, the amount of water suctioned into the combustion chamber via intake port 9 during the induction stroke of the internal combustion engine could be controlled. Thus, the water and the fuel oil could be mixed in an appropriate rate with the combustion chamber, therefore, the combustion efficiency of the fuel oil could be improved, and the fuel consumption and environmental pollution could be reduced.

As shown in FIG. 1, the water processing unit 4 and the water amount control unit 6 may be mounted within the water tank 2, to minimize the size of the fuel-saving accelerator 1 and integrate the components thereof. Alternatively, the water processing unit 4 and the water amount control unit 6 may also be mounted outside of the water tank 2, to increase the capacity of the water tank 2.

The operation of the fuel-saving accelerator of the present invention is as follows. Firstly, the water tank 2 supplies water to the water processing unit 4, and then the water processing unit 4 supplies the water processed therein to the water amount control unit 6. Next, during the induction stroke of the internal combustion engine 11, the controlled amount of water is suctioned into the combustion chamber 10 through the intake port 9 from the water amount control unit 6. The suctioned water will mix with the fuel oil in the combustion chamber. During the compression stroke of the internal combustion engine, the suctioned water would release hydrogen under the condition of high temperature and high pressure within the combustion chamber. The hydrogen may assist in improving the combustion efficiency of the fuel oil, thus, the dynamic performance of the internal combustion engine could be enhanced, and the fuel consumption and environmental pollution could be reduced.

To verify the fuel-saving performance of the fuel-saving accelerator of the present invention, the present applicant entrusted the China National Quality Control & Inspection Center for Automobiles (Xiang Fan) to have comparison tests on the performance of the samples with or without the fuel-saving accelerator of the present invention. The samples are based on the vehicles Honda Odyssey (manufactured by Guangzhou Honda Automobile Co., Ltd. in China) and Landwind (manufactured by Jiangling Motors Corporation, Ltd. in China). The standards adopted in the comparison tests are “Passenger Car—Fuel Consumption Test Method” (GB/T 12545.1-2001), “Motor Vehicles—Acceleration Performance—Test Method” (GB/T 12543-1990), “Motor vehicles—Maximum Speed—Test Method” (GB/T 12544-1990), “Motor Vehicles—Minimum Stable Speed—Test Method” (GB/T 12547-1990), and “Motor Vehicles—Steep Hill Climbing—Test Method” (GB/T 12539-1990).

### TEST 1

Honda Odyssey is used as the basis of the samples 1 and 2 of the test 1, in which the sample 1 is a sample without a fuel-saving accelerator of the present invention, while the sample 2 is a sample provided with the present fuel-saving accelerator. The cylinder capacity of Honda Odyssey is 2400 cc and the fuel consumption is 7.46 L/100 km=0.0746 L/km, thus, the diameter d of the through hole 15 of the water amount control unit 6 is d=(0.0746/2400)*8000=0.24867 mm. The test results of the test 1 are listed in the following table 1.

TABLE 1

| | | Test Result | |
|---|---|---|---|
| Test Item | | Sample 1 | Sample 2 |
| Maximum speed (km/h) | | 196.7 | 197.2 |
| Acceleration from standing | Time (s) | 26.2 | 22.1 |
| start to 130 km/h | Distance (m) | 605.2 | 513.5 |
| Climbing Degree (30%) | | 30% | 30% |
| | | Rotational | Rotational |
| | | speed | speed |
| | | 4000 r/min | 3900 r/min |
| Fuel Consumption on | 50 km/h | 6.38 | 6.26 |
| uniform speed with | 90 km/h | 7.46 | 7.22 |
| maximum drive | 120 km/h | 9.97 | 9.44 |
| transmission (L/100 km) | | | |

As shown in table 1, after provided with the present fuel-saving accelerator, the dynamic performance of the prototype Honda Odyssey is improved obviously, and the fuel consumption of its internal combustion engine is decreased at the same time. FIG. 4 shows the V-T curve graph of the samples 1 and 2 during the acceleration from standing start, and FIG. 5 shows the V-S curve graph of the samples 1 and 2 during the acceleration from standing start. Also shown in the FIGS. 4 and 5, after provided with the present fuel-saving accelerator, the dynamic performance, especially the acceleration capability of the prototype is enhanced significantly.

### TEST 2

Landwind is used as basis of the sample 3 and 4 of the test 2, in which the sample 3 is a sample without a fuel-saving accelerator of the present invention, while the sample 4 is a sample provided with the present fuel-saving accelerator. The cylinder capacity of Landwind is 2000 cc and the fuel consumption is 12.17 L/100 km=0.01217L/km, thus, the diameter d of the through hole 15 of the water amount control unit 6 is d=(0.01217/2000)*8000=0.4868 mm. The test results of the test 2 are listed in the following table 2.

TABLE 2

| | | Test Result | |
|---|---|---|---|
| Test Item | | Sample 3 | Sample 4 |
| Minimum stable speed with direct drive | | 25.5 | 25.3 |
| transmission (km/h) | | | |
| Minimum stable speed with maximum | | 25.8 | 25.6 |
| drive transmission (km/h) | | | |
| Climbing Degree (30%) | | 30% | 30% |
| | | Rotational | Rotational |
| | | speed | speed |
| | | 5200 r/min | 5000 r/min |
| Acceleration from standing | Time (s) | 42.3 | 40.9 |
| start to 120 km/h | Distance (m) | 1004.5 | 975.4 |
| Acceleration from 30 km/h | Time (s) | 43.1 | 39.7 |
| to 110 km/h with direct | Distance (m) | 910.5 | 837.2 |
| drive transmission | | | |
| Acceleration from 30 km/h | Time (s) | 60.0 | 54.6 |
| to 110 km/h with maximum | Distance (m) | 1314.7 | 1179.9 |
| drive transmission | | | |
| Fuel Consumption on | 90 km/h | 12.17 | 11.72 |
| uniform speed with | 110 km/h | 15.42 | 14.56 |
| maximum drive | | | |
| transmission (L/100 km) | | | |

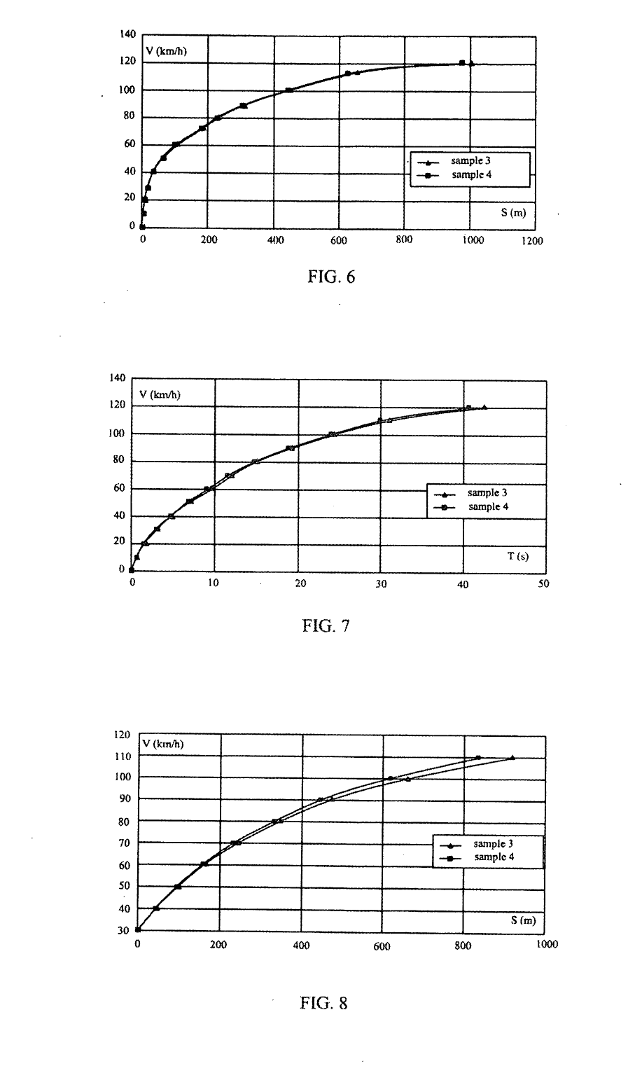

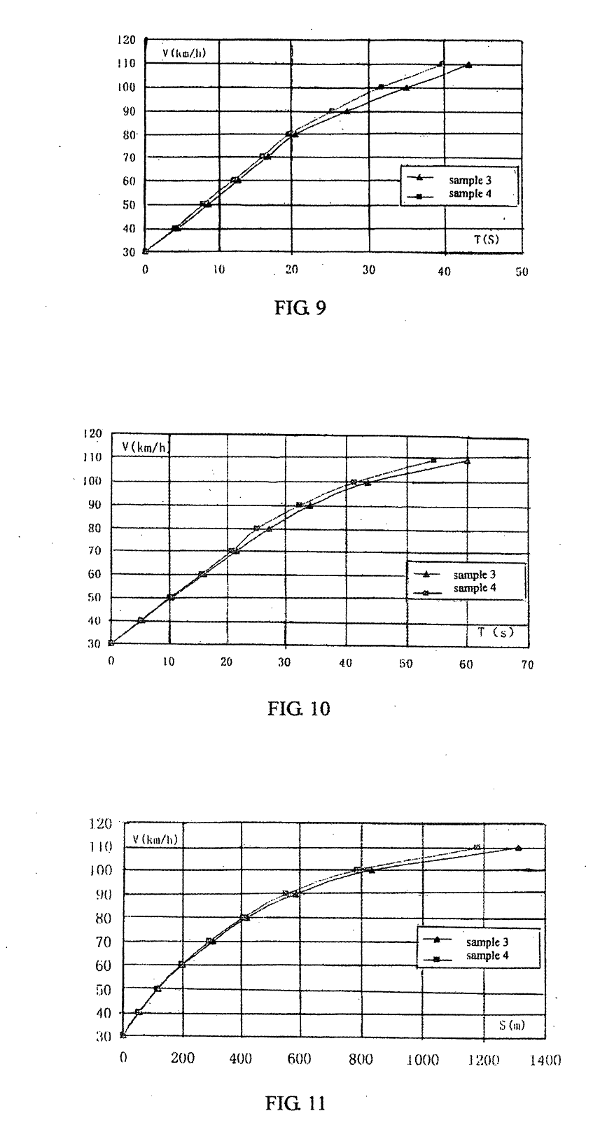

As shown in table 2, after provided with the present fuel-saving accelerator, the dynamic performance of the prototype Landwind is improved obviously, and the fuel consumption of its internal combustion engine is decreased at the same time. FIG. 6 shows the V-S curve graph of the samples 3 and 4 during the acceleration from standing start, FIG. 7 shows the V-T curve graph of the samples 3 and 4 during the acceleration from standing start, FIG. 8 shows the V-S curve graph of the samples 3 and 4 during the acceleration from 30 km/h to 110 km/h with direct drive transmission, FIG. 9 shows the V-T curve graph of the samples 3 and 4 during the acceleration from 30 km/h to 110 km/h with direct drive transmission, FIG. 10 shows the V-S curve graph of the samples 3 and 4 during the acceleration from 30 km/h to 110 km/h with maximum drive transmission, and FIG. 11 shows the V-T curve graph of the samples 3 and 4 during the acceleration from 30 km/h to 110 km/h with maximum drive transmission. Also shown in the FIGS. 6-11, after provided with the present fuel-saving accelerator, the dynamic performance, especially the acceleration capability of the prototype is enhanced significantly.

Although the description of the present invention is made with reference to the preferred embodiments, the present invention is not limited to these embodiments. Various modifications and changes can be made to the invention by those skilled in the art without departing from the spirit and scopes of the present invention.

What is claimed is:

1. A fuel-saving accelerator for internal combustion engine, comprising:
a water tank for storing water therein as auxiliary fuel for the inner combustion engine;
a water processing unit communicating with the water tank to process the water supplied from the water tank; and
a water amount control unit connected between the water processing unit and a combustion chamber of the internal combustion engine to control the amount of the processed water supplied from the water processing unit and supply a controlled amount of water to the combustion chamber.

2. The fuel-saving accelerator for internal combustion engine according to claim 1, wherein the water processing unit comprises an inlet and an outlet formed at opposite ends thereof and an inner cavity provided between the inlet and the outlet, in which the inner cavity contains materials for processing the water.

3. The fuel-saving accelerator for internal combustion engine according to claim 2, wherein the inner cavity is provided with organic absorption cotton for absorbing particles and impurities in the water, absorbent charcoal for absorbing the harmful metals and other heavy metals in the water, and ion-exchange resin for lowering the concentration of calcium and magnesium ion in the water.

4. The fuel-saving accelerator for internal combustion engine according to claim 3, wherein the water processing unit adjusts the pH value of the water to pH 6˜8.

5. The fuel-saving accelerator for internal combustion engine according to claim 1, wherein the water processing unit is provided within the water tank.

6. The fuel-saving accelerator for internal combustion engine according to claim 2, wherein the water processing unit is provided within the water tank.

7. The fuel-saving accelerator for internal combustion engine according to claim 3, wherein the water processing unit is provided within the water tank.

8. The fuel-saving accelerator for internal combustion engine according to claim 4, wherein the water processing unit is provided within the water tank.

9. The fuel-saving accelerator for internal combustion engine according to claim 1, wherein the water amount control unit comprises a through hole formed therein, and an inlet and an outlet formed at opposite ends of the through hole.

10. The fuel-saving accelerator for internal combustion engine according to claim 6, wherein the diameter of the through hole is determined according to the following equation,
d=(Fc/Cc)*Apui
where d is the diameter of the through hole, Apui is a constant value of 8000, Fc is the fuel consumption of the internal combustion engine, while Cc is the cylinder capacity of the internal combustion engine.

11. The fuel-saving accelerator for internal combustion engine according to claim 7, wherein the water amount control unit is connected to an intake port of the combustion chamber through a connection tube, to supple a controlled amount of water to the combustion chamber during the induction stroke of the internal combustion engine.

12. The fuel-saving accelerator for internal combustion engine according to claim 9, wherein the water amount control unit is provided within the water tank.

13. The fuel-saving accelerator for internal combustion engine according to claim 10, wherein the water amount control unit is provided within the water tank.

14. The fuel-saving accelerator for internal combustion engine according to claim 11, wherein the water amount control unit is provided within the water tank.
